(19) United States
(12) Patent Application Publication
(10) Pub. No.: US 2013/0211108 A1
(43) Pub. Date: Aug. 15, 2013

(54) NOVEL PROCESS FOR THE PREPARATION OF (3S)-TETRAHYDROFURAN-3-YL (IS, 2R)-3-[[(4-AMINOPHENYL) SULFONYL] (ISOBUTYL) AMINO]-1-BENZYL-2-(PHOSPHONOOXY) PROPYLCARBAMATE AND ITS PHARMACEUTICALLY ACCEPTABLE SALTS

(71) Applicants: Siva Rama Prasad Vellanki, Hyderabad (IN); Madhu Murthy Nadella, Hyderabad (IN); Rajendra Reddy Mulamalla, Hyderabad (IN); Siva Koteswara Rao Prathi, Hyderabad (IN); Ravathi Srinivas Rambhotla, Hyderabad (IN); Siva Reddy Arumalla, Hyderabad (IN); Debashish Datta, Hyderabad (IN)

(72) Inventors: Siva Rama Prasad Vellanki, Hyderabad (IN); Madhu Murthy Nadella, Hyderabad (IN); Rajendra Reddy Mulamalla, Hyderabad (IN); Siva Koteswara Rao Prathi, Hyderabad (IN); Ravathi Srinivas Rambhotla, Hyderabad (IN); Siva Reddy Arumalla, Hyderabad (IN); Debashish Datta, Hyderabad (IN)

(73) Assignee: Mylan Laboratories Ltd

(21) Appl. No.: 13/805,048

(22) PCT Filed: Jun. 17, 2011
(86) PCT No.: PCT/IN11/00410

§ 371 Date: Apr. 2, 2013

(30) Foreign Application Priority Data
Jun. 18, 2010 (IN) 1703/CHE/2010

(51) Int. Cl. C07F 9/655; C07F 9/145

(52) U.S. Cl. CPC C07F 9/65515; C07F 9/145
USPC 549/475; 558/175

(57) ABSTRACT

The present invention relates to a novel process for the preparation of Fosamprenavir or its pharmaceutically acceptable salts thereof by using novel intermediates.

This application claims priority to Indian patent application No. 1376/CHE/2010 filed on Jun. 17, 2010, the contents of which are incorporated by reference in their entirety.

### FIELD OF THE INVENTION

The present invention relates to a novel process for the preparation of (3S)-tetrahydrofuran-3-yl (1S,2R)-3 [[(4-aminophenyl)sulfonyl](isobutyl)amino]-1-benzyl-2-(phosphonooxy) propylcarbamate (Fosamprenavir) and its pharmaceutically acceptable salts thereof by using novel intermediates.

### BACKGROUND OF THE INVENTION

Fosamprenavir calcium is an antiviral compound having HIV aspartyl protease inhibitory activity and is particularly well suited for inhibiting HIV-1 and HIV-2 viruses. The chemical name for Fosamprenavir calcium is (3S)-tetrahydrofuran-3-yl (1S,2R)-3-[[(4-aminophenyl)sulfonyl](isobutyl)amino]-1-benzyl-2-(phosphonooxy) propylcarbamate monocalcium salt and is structurally represented as shown below:

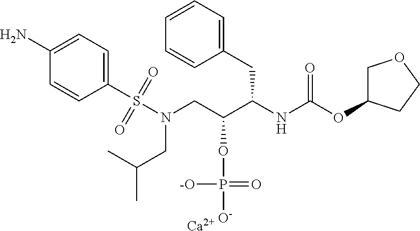

(3S) tetrahydro-3-furanyl (1S,2R)-3-[[((4-aminophenyl)sulfonyl](isobutyl)amino]-1-benzyl-2-(phosphonooxy)propylcarbamate has increased solubility in the pH range of the gastro-intestinal tract compared to the HIV protease inhibitor [3S-[3R*(1R*,2S*)]]-[3-[[(4-aminophenyl)sulfonyl](2-methyl-propyl)amino]-2-hydroxy-1-phenylmethyl)propyl]-tetrahydro-3-furanyl ester (amprenavir, 141W94). Amprenavir, which has poor solubility is available as a solution in gel capsules and has a high pill burden. This new HIV protease inhibitor (fosamprenavir calcium) with its increased solubility has the potential to reduce the perceived pill burden and may be formulated as a tablet.

U.S. Pat. No. 6,436,989B1 patent disclosed a range of pharmaceutical acceptable salts of forsamprenavir including both organic and inorganic salts such as sodium, potassium, magnesium, calcium, zinc, ethylene diamine and the like. The Scheme disclosed in US '989 is depicted below;

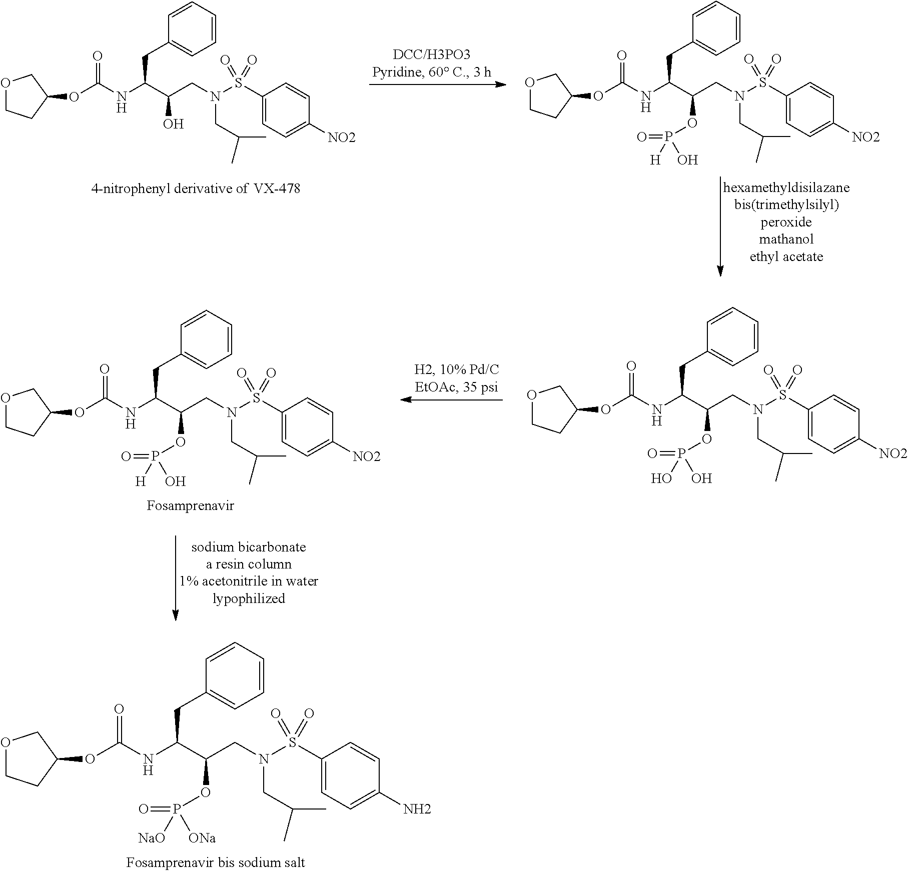

U.S. Pat. No. 6,514,953B1 patent disclosed a process for the preparation of crystalline form 1 of (3S)-tetrahydrofuran-3-yl(1S,2R)-3-[[(4-aminophenyl)sulfonyl](isobutyl)amino]-1-benzyl-2-(phosphonooxy) propylcarbamate monocalcium salt by using Amprenavir intermediates.

Prior art processes gives low yields due to formation of impurities in final compound. It is difficult to get the pure Fosamprenavir or its salts. Thus, there is a need to develop an improved process, which can yield pure Fosamprenavir or its salts thereof

The present invention relates to novel and economically feasible process for the preparation of (3S)-tetrahydrofuran-3-yl (1S,2R)-3-[[(4-aminophenyl)sulfonyl]-(isobutyl)amino]-1-benzyl-2-(phosphonooxy) propylcarbamate (Fosamprenavir) or its pharmaceutically acceptable salts thereof by using novel intermediates.

### OBJECTIVE & SUMMARY OF THE INVENTION

The main object of the present invention relates to a novel process for the preparation of

(3 S)-tetrahydrofuran-3-yl(1S ,2R)-3-[[(4-aminophenyl)sulfonyl](isobutyl)amino]-1-benzyl-2-(phosphonooxy) propylcarbamate or its pharmaceutically acceptable salts thereof.

Yet Another object of the present invention relates to a novel process for the preparation of (3S)-tetrahydrofuran-3-yl (1S,2R)-3-[[(4-aminophenyl)sulfonyl](isobutyl)amino]-1-benzyl-2-(phosphonooxy) propylcarbamate monocalcium salt using novel intermediate (2R,3S)-3-amino-1-(N-isobutyl-4-nitrophenyl sulfonamide)-4-phenylbutan-2-yl dihydogen phosphate or its salts thereof.

Yet another object of the present invention relates to a process for the preparation of (3S)-tetrahydrofuran-3-yl(1S ,2R)-3-[[(4-aminophenyl)sulfonyl](isobutyl)amino]-1-benzyl-2-(phosphonooxy) propylcarbamate or its pharmaceutically acceptable salts as depicted in the scheme-1 below:

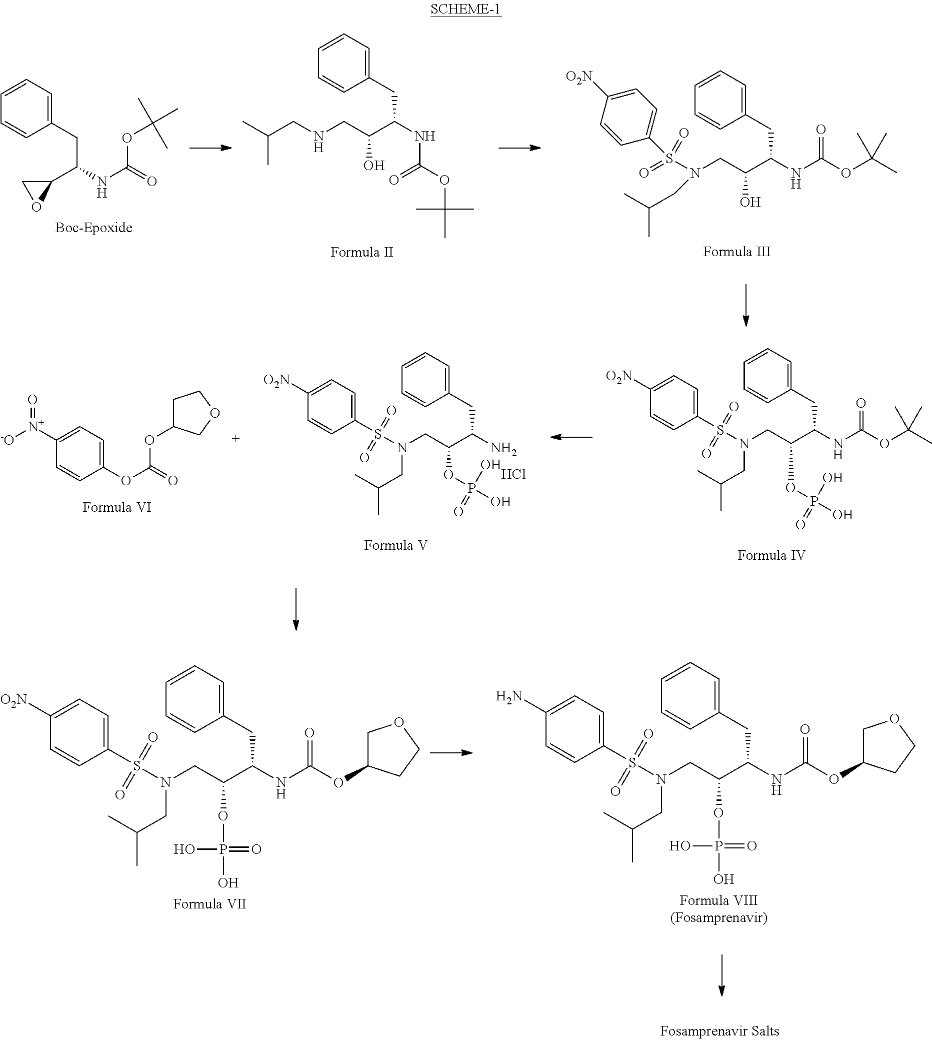

### DETAILED DESCRIPTION OF THE INVENTION

The main embodiment of the present invention relates to novel process for the preparation of (3S)-tetrahydrofuran-3-yl(1S,2R)-3-[[(4-aminophenyl)sulfonyl](isobutyl) amino]-1-benzyl-2-(phosphonooxy) propylcarbamate or its pharmaceutically acceptable salts thereof.

Another embodiment of the present invention relates to (2R,3S)-3-amino-1-(N-isobutyl-4-nitrophenyl sulfonamide)-4-phenylbutan-2-yl dihydogen phosphate or its salts and process for the preparation thereof.

Yet another embodiment of the present invention relates to a novel process for the preparation of (3S)-tetrahydrofuran-3-yl (1S,2R)-3-[[(4-aminophenyl)sulfonyl](isobutyl)amino]-1-benzyl-2-(phosphonooxy) propylcarbamate monocalcium salt by using novel intermediates selected form a) (2R,3S)-3-amino-1-(N-isobutyl-4-nitrophenyl sulfonamide)-4-phenylbutan-2-yl dihydogen phosphate or its salts thereof b) tert-butyl (2S,3R)-4-(N-isobutyl-4-nitrophenylsulfonamido)-1-phenyl-3-(phosphonooxy)butan-2-ylcarbamate or its salts thereof.

Yet another embodiment of the present invention relates to a process for the preparation of (3S)-tetrahydrofuran-3-yl(1S,2R)-3-[[(4-aminophenyl)sulfonyl](isobutyl)amino]-1-benzyl-2-(phosphonooxy) propylcarbamate or its pharmaceutically acceptable salts thereof comprising the steps of

i) reacting the compound of formula II with 4-nitrophenylsulfonylchloride in presence of a suitable base and solvent to give compound of formula III

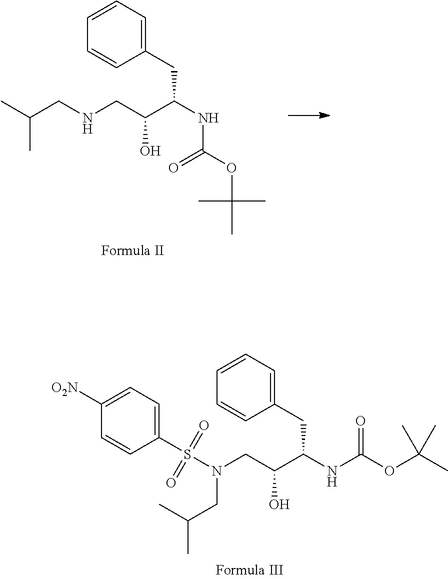 [SMILES: CC(C)CNC[C@@H](O)[C@H](Cc1ccccc1)NC(=O)OC(C)(C)C ; CC(C)CN(C[C@@H](O)[C@H](Cc1ccccc1)NC(=O)OC(C)(C)C)S(=O)(=O)c1ccc([N+](=O)[O-])cc1]

ii) reacting the compound of formula III with a phosphorylating agent in presence of a base and solvent to give compound of formula IV

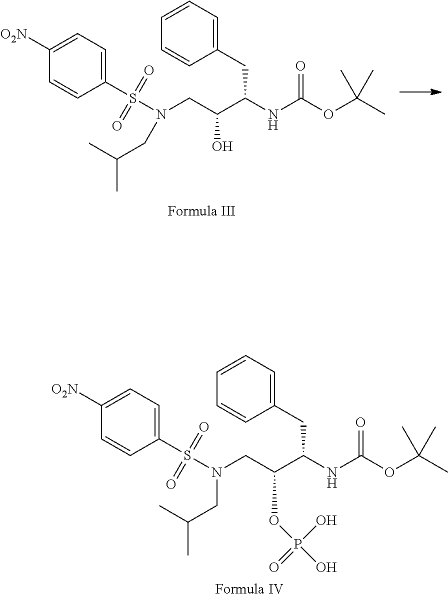 [SMILES: CC(C)CN(C[C@@H](O)[C@H](Cc1ccccc1)NC(=O)OC(C)(C)C)S(=O)(=O)c1ccc([N+](=O)[O-])cc1 ; CC(C)CN(C[C@@H](OP(=O)(O)O)[C@H](Cc1ccccc1)NC(=O)OC(C)(C)C)S(=O)(=O)c1ccc([N+](=O)[O-])cc1]

iii) deprotecting the compound of formula IV to give compound of formula V

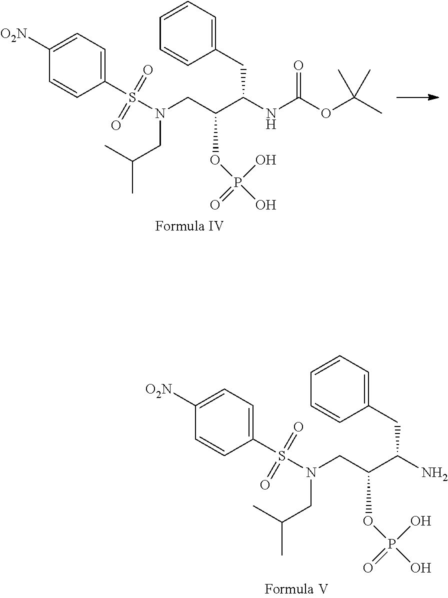 [SMILES: CC(C)CN(C[C@@H](OP(=O)(O)O)[C@H](Cc1ccccc1)NC(=O)OC(C)(C)C)S(=O)(=O)c1ccc([N+](=O)[O-])cc1 ; CC(C)CN(C[C@@H](OP(=O)(O)O)[C@@H](N)Cc1ccccc1)S(=O)(=O)c1ccc([N+](=O)[O-])cc1]

iv) reacting the compound of formula V with compound of formula VI to give compound of formula VII

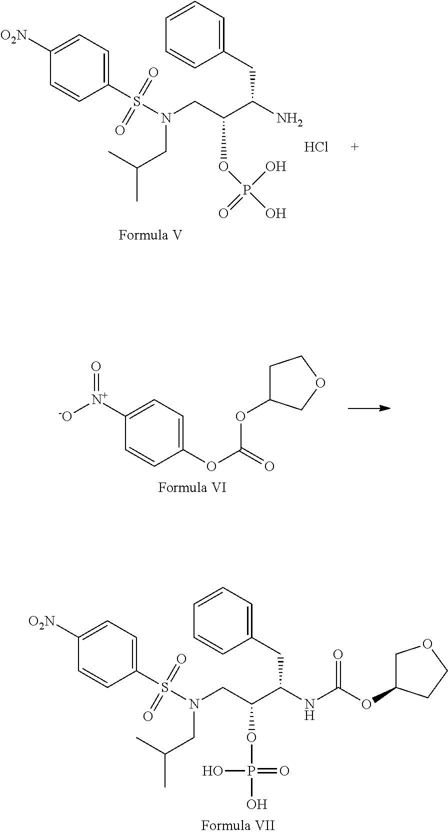

v) reducing the compound of formula VII to form (3S)-tetrahydrofuran-3-yl(1S,2R)-3-[[(4-aminophenyl)sulfonyl](isobutyl)amino]-1-benzyl-2-(phosphonooxy) propylcarbamate.

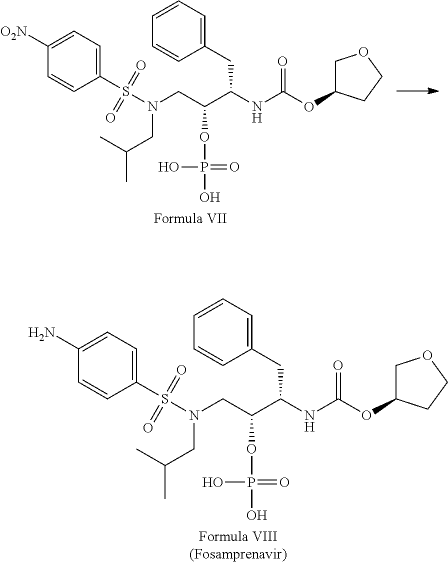 [SMILES: CC(C)CN(C[C@@H](OP(=O)(O)O)[C@H](Cc1ccccc1)NC(=O)O[C@@H]1CCOC1)S(=O)(=O)c1ccc([N+](=O)[O-])cc1 ; CC(C)CN(C[C@@H](OP(=O)(O)O)[C@H](Cc1ccccc1)NC(=O)O[C@@H]1CCOC1)S(=O)(=O)c1ccc(N)cc1]

vi) converting the compound of formula VIII (Fosamprenavir) into its pharmaceutically acceptable salts.

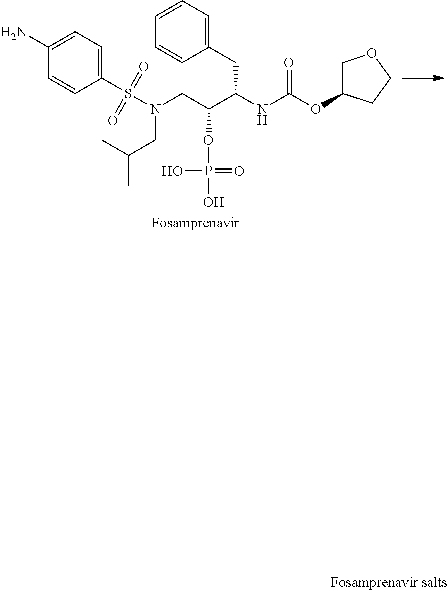 [SMILES: CC(C)CN(C[C@@H](OP(=O)(O)O)[C@H](Cc1ccccc1)NC(=O)O[C@@H]1CCOC1)S(=O)(=O)c1ccc(N)cc1]

According to the present invention the compound of formula II is prepared from Boc-epoxide by treatment with suitable alkylamine such as isobutylamine in presence of a suitable organic solvent such as alcohols preferably isoprapanol. The amino alcohol of formula II is then reacted with 4-nitrophenylsulfonyl chloride in presence of a base selected from organic base such as pyridine, triethylamine, ammonia or inorganic base such as metal hydroxides or metal carbonates and organic solvent to afford compound of formula III.

The compound of formula III is then phosphorylated using phosphorous acid, phosphorous oxychloride or phosphoric acid in presence of a base selected from organic base such as pyridine, triethylamine, ammonia or inorganic base such as metal hydroxides or metal carbonates and organic solvent to give compound of formula IV. By deprotecting the compound of formula IV using inorganic acid such as hydrochloric acid affords compound of formula V in its free base or salt form. The compound of formula V is then reacted with carbonic acid 4-nitrophenyl ester tetrahydro-furan-3yl-ester to give compound of formula VII which is then reduced using conventional techniques to give compound of formula VIII.

The compound of formula VIII (Fosamprenavir) is optionally converted into its pharmaceutically acceptable salts.

According to the present invention the organic solvent used in the various steps are selected from water; ketones such as acetone, methyl isobutyl ketone, methyl ethyl ketone and cyclohexanone; alcohols such as methanol, ethanol, isopropanol, n-propanol, n-butanol, tertiary-butyl alcohol, cyclohexanol; chlorinated solvents such as dichloromethane, chloroform, carbon tetrachloride; hydrocarbon solvents such as toluene, xylene, n-hexane, n-heptane, cyclohexane; esters such as ethyl acetate, n-propyl acetate, n-butyl acetate, t-butyl acetate; ethers such as diethyl ether, dimethyl ether, diisopropyl ether; nitriles such as acetonitrile, propionitrile; or polar aprotic solvents like dimethyl sulfoxide, dimethyl formamide and dioxane or a mixture of thereof.

Yet another embodiment of the present invention relates to tert-butyl (2S,3R)-4-(N-isobutyl-4-nitrophenylsulfonamido)-1-phenyl-3-(phosphonooxy)butan-2-ylcarbamate of formula IV.

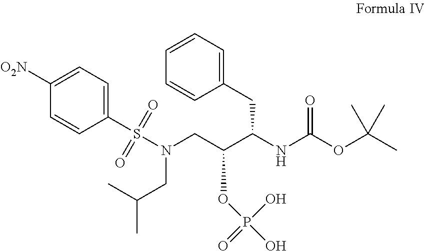 [SMILES: CC(C)CN(C[C@@H](OP(=O)(O)O)[C@H](Cc1ccccc1)NC(=O)OC(C)(C)C)S(=O)(=O)c1ccc([N+](=O)[O-])cc1]

Yet another embodiment of the present invention relates to (2R,3S)-3-amino-1-(N-isobutyl-4-nitrophenyl sulfonamide)-4-phenylbutan-2-yl dihydogen phosphate or its salts.

Yet another embodiment of the present invention relates to hydrochloride salt of (2R,3S)-3-amino-1-(N-isobutyl-4-nitrophenyl sulfonamide)-4-phenylbutan-2-yl dihydogen phosphate of formula V.

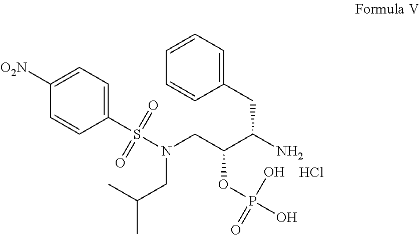 [SMILES: CC(C)CN(C[C@@H](OP(=O)(O)O)[C@@H](N)Cc1ccccc1)S(=O)(=O)c1ccc([N+](=O)[O-])cc1 ; Cl]

Yet another embodiment of the present invention relates to (2R,3S)-3-amino-1-(N-isobutyl-4-aminophenyl sulfonamide)-4-phenylbutan-2-yl dihydogen phosphate of formula IX or its salts.

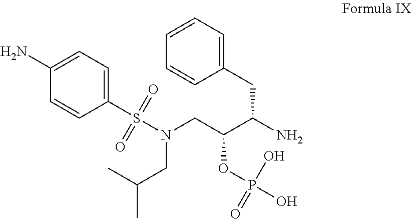 [SMILES: CC(C)CN(C[C@@H](OP(=O)(O)O)[C@@H](N)Cc1ccccc1)S(=O)(=O)c1ccc(N)cc1]

In yet another embodiment, the present invention relates to process for the preparation of fosamrpenavir or its salts as depicted in scheme-2 below.

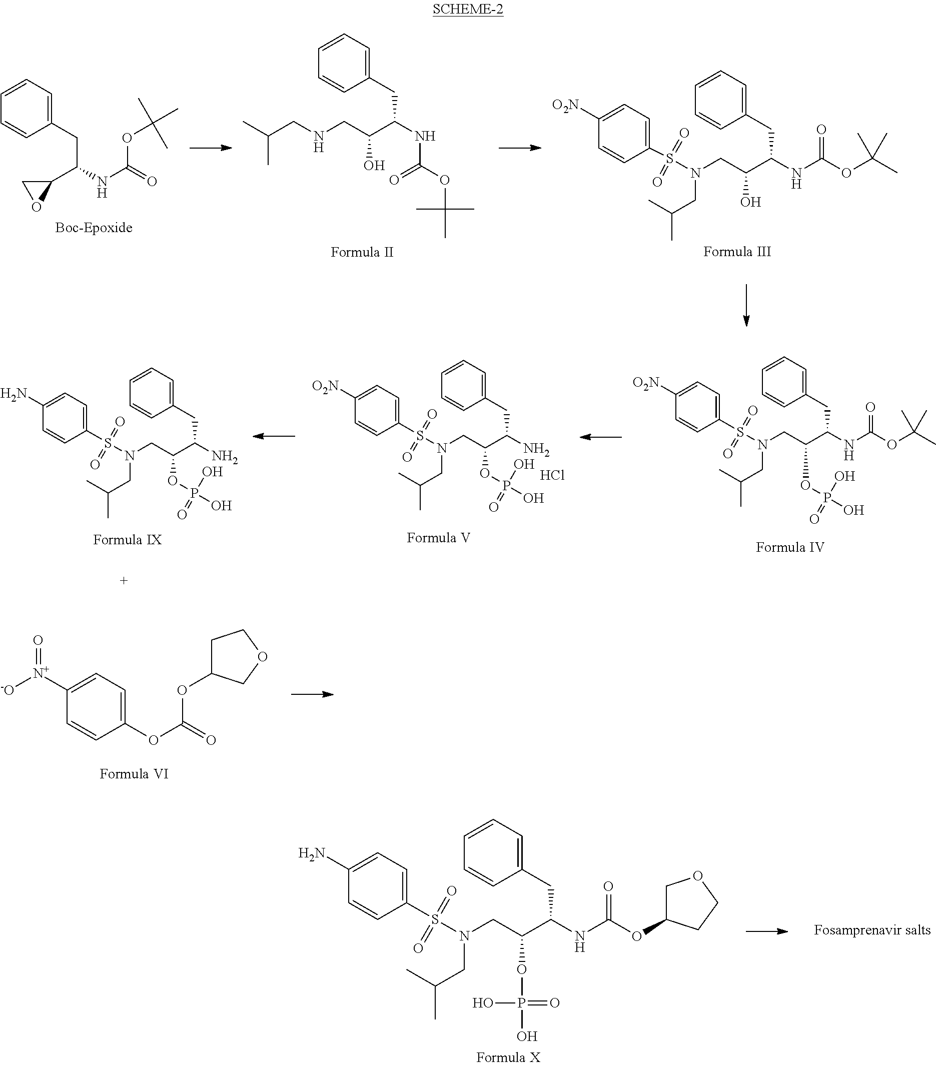

### EXAMPLE

### Example 1

### Process for the Preparation of (2R, 3S)-3-amino-1-(N-isobutyl-4-nitrophenylsulfonamido)-4-phenylbutan-2-yl dihydrogen phosphate

Tert-butyl (2S,3R)-3-hydroxy-4-(N-isobutyl-4-nitrophenylsulfonamido)-1-phenylbutan-2-ylcarbamate was dissolved in Pyridine 25-35° C., cooled the mass to 0-5° C., added freshly distilled phosphorus oxychloride (4.36 ml) at 0-5° C. over a period of 5 min, heated the mass to 25-35° C. over a period of 10 min, stirred the mass at 25-35° C. for a period of 3 hours. Cooled the mass to 0-5° C. over a period of 10 min and added purified water (100 ml) followed by addition of Methyl isobutyl ketone at 25-35° C. and separated the layers. Methyl isobutyl ketone was added to the aqueous layer at 25-35° C. and separated the layers. To the combined aqueous layers was added 2M Hydrochloric acid (200 ml) at 25-35° C. Distilled off the solvent under vacuum at 50° C. and isolated the title compound as yellow foam.

### Example 2

### Process for the Preparation of tert-butyl (2S,3R)-4-(N-isobutyl-4-nitrophenylsulfonamido)-1-phenyl-3-(phosphonooxy)butan-2-ylcarbamate

(2R,3 S)-3 -amino-1-(N-isobutyl-4-nitrophenylsulfonamido)-4-phenylbutan-2-yl dihydrogen phosphate was dissolved in Ethyl acetate at a temperature at about 25-35° C. Stirred the reaction mass for 10 min and added aqueous hydrochloric acid and heated the mass to 50-55° C. Cooled the reaction mass to 25-35° C. over a period of 20 min and added 30% aqueous sodium hydroxide to the reaction mass, filtered off the mass and washed the bed with Isopropanol and dried to obtain the title compound

### Example 3

### Process for the Preparation of Fosamprenavir Calcium

tert-butyl (2S,3R)-4-(N-isobutyl-4-nitrophenylsulfonamido)-1-phenyl-3-(phosphonooxy)butan-2-ylcarbamate was dissolved in acetonitrile, stirred the reaction mass, added Diisopropyl ethyl amine(3.6 gm, 1.5 mole eq) at 25-35° C. To the reaction mixture added NTC at 25 to 35° C., raised the temperature to 70-75° C. Distilled off solvent completely u/vacuum, Ethyl acetate (50 ml) was added to the reaction mass. Separated both the layers. Aqueous layer was taken in an autoclave vessel at 25-35° C., Charged Ethanol(50 ml) and 10% Palladium on Charcoal(0.5 gm, 50% wet). Stirred the reaction mass under 4-5 Kg/cm2 hydrogen atmosphere at 25-35° C. for 4- 5 hours. After completion of the reaction, filtered the reaction mass over hyflo and washed the funnel with Ethanol(20 ml), heated the reaction mass, stirred for 30 minutes at 50° C. Added Calcium acetate solution at 50±2° C. for 30 to 60 minutes. Filtered the solids and washed the cake with Ethanol(10 ml) and purified water (10 ml) mixture and dried to obtain the title compound.

1. A process for the preparation of (3S)-tetrahydrofuran-3-yl(1S,2R)-3-[[(4-aminophenyl)sulfonyl](isobutyl)amino]-1-benzyl-2-(phosphonooxy) propylcarbamate (fosamprenavir) or its pharmaceutically acceptable salts thereof, comprising the steps of
i) reacting the compound of formula II with 4-nitrophenylsulfonylchloride to give a compound of formula III 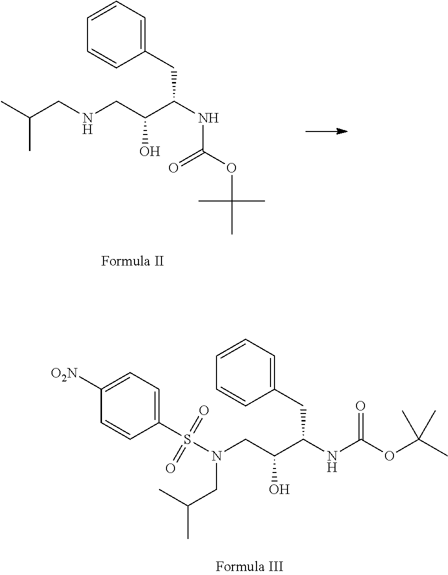 [SMILES: CC(C)CNC[C@@H](O)[C@H](Cc1ccccc1)NC(=O)OC(C)(C)C ; CC(C)CN(C[C@@H](O)[C@H](Cc1ccccc1)NC(=O)OC(C)(C)C)S(=O)(=O)c1ccc([N+](=O)[O-])cc1]
ii) reacting the compound of formula III with a phosphorylating agent in the presence of a base and solvent to give a compound of formula IV 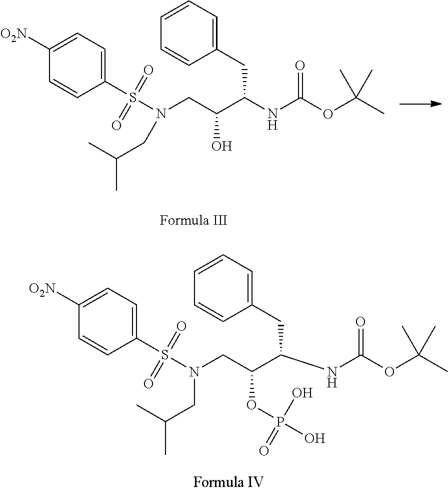 [SMILES: CC(C)CN(C[C@@H](O)[C@H](Cc1ccccc1)NC(=O)OC(C)(C)C)S(=O)(=O)c1ccc([N+](=O)[O-])cc1 ; CC(C)CN(C[C@@H](OP(=O)(O)O)[C@H](Cc1ccccc1)NC(=O)OC(C)(C)C)S(=O)(=O)c1ccc([N+](=O)[O-])cc1]
iii) deprotecting the compound of formula IV to give a compound of formula V 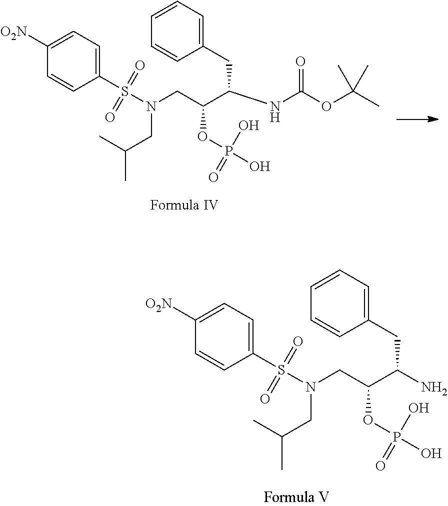 [SMILES: CC(C)CN(C[C@@H](OP(=O)(O)O)[C@H](Cc1ccccc1)NC(=O)OC(C)(C)C)S(=O)(=O)c1ccc([N+](=O)[O-])cc1 ; CC(C)CN(C[C@@H](OP(=O)(O)O)[C@@H](N)Cc1ccccc1)S(=O)(=O)c1ccc([N+](=O)[O-])cc1]
iv) reacting the compound of formula V with a compound of formula VI to give a compound of formula VII 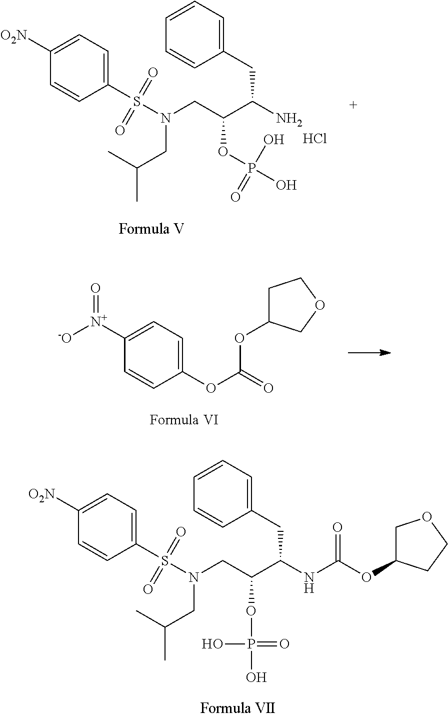
v) reducing the compound of formula VII to form (3S)-tetrahydrofuran-3-yl(1S,2R)-3-[[(4-aminophenyl)sulfonyl](isobutyl)amino]-1-benzyl-2-(phosphonooxy) propylcarbamate. 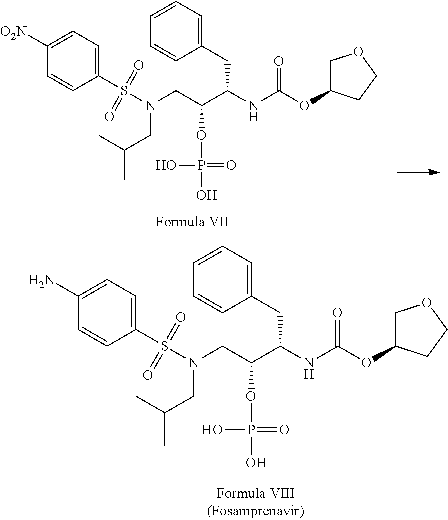 [SMILES: CC(C)CN(C[C@@H](OP(=O)(O)O)[C@H](Cc1ccccc1)NC(=O)O[C@@H]1CCOC1)S(=O)(=O)c1ccc([N+](=O)[O-])cc1 ; CC(C)CN(C[C@@H](OP(=O)(O)O)[C@H](Cc1ccccc1)NC(=O)O[C@@H]1CCOC1)S(=O)(=O)c1ccc(N)cc1]
vi) optionally converting the compound of formula VIII (Fosamprenavir) into its pharmaceutically acceptable salts.

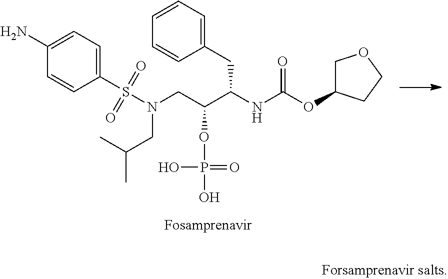 [SMILES: CC(C)CN(C[C@@H](OP(=O)(O)O)[C@H](Cc1ccccc1)NC(=O)O[C@@H]1CCOC1)S(=O)(=O)c1ccc(N)cc1]

2. The process according to claim 1, wherein the phosphorylating agent is selected from the group consisting of phosphorous acid, phosphorous oxychloride Of and phosphoric acid.

3. The process according to claim 1, wherein the base is an selected from organic or an inorganic base.

4. The process according to claim 3, wherein the organic base is selected from the group consisting of pyridine, and triethyl amine and the inorganic base is selected from the group consisting of sodium carbonate, sodium hydroxide, potassium hydroxide and potassium bicarbonate.

5. The process according to claim 1, wherein the de-protection is carried out using an inorganic acid.

6. The process according to claim 1, wherein the condensation of step iv is carried out in the presence of Diisopropyl ethyl amine or triethyl amine.

7. A compound of the following formula or a salt thereof

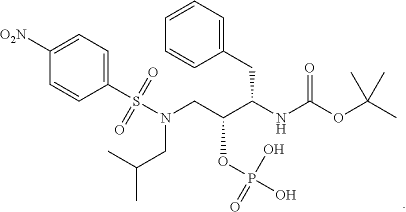 [SMILES: CC(C)CN(C[C@@H](OP(=O)(O)O)[C@H](Cc1ccccc1)NC(=O)OC(C)(C)C)S(=O)(=O)c1ccc([N+](=O)[O-])cc1]

8. (canceled)

9. A compound of the following formula or a salt thereof

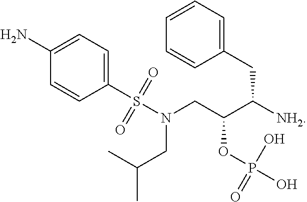 [SMILES: CC(C)CN(C[C@@H](OP(=O)(O)O)[C@@H](N)Cc1ccccc1)S(=O)(=O)c1ccc(N)cc1]

10. A process for the preparation of Fosamprenavir calcium comprising the use of at least one compound selected from the following group as an intermediate:
a) a compound of formula 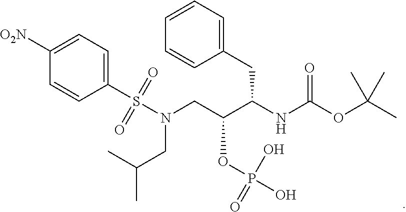 [SMILES: CC(C)CN(C[C@@H](OP(=O)(O)O)[C@H](Cc1ccccc1)NC(=O)OC(C)(C)C)S(=O)(=O)c1ccc([N+](=O)[O-])cc1]
b) a compound of one of formulas 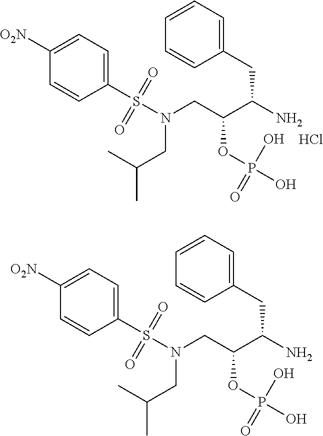 [SMILES: CC(C)CN(C[C@@H](OP(=O)(O)O)[C@@H](N)Cc1ccccc1)S(=O)(=O)c1ccc([N+](=O)[O-])cc1 ; Cl ; CC(C)CN(C[C@@H](OP(=O)(O)O)[C@@H](N)Cc1ccccc1)S(=O)(=O)c1ccc([N+](=O)[O-])cc1]
c) a compound of formula

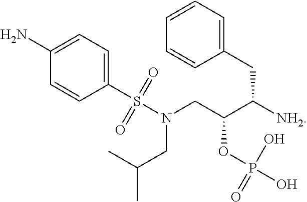 [SMILES: CC(C)CN(C[C@@H](OP(=O)(O)O)[C@@H](N)Cc1ccccc1)S(=O)(=O)c1ccc(N)cc1]

11. A compound of the following formula or a salt thereof

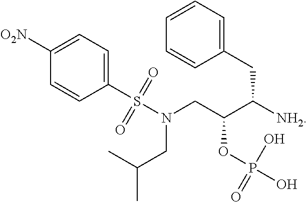 [SMILES: CC(C)CN(C[C@@H](OP(=O)(O)O)[C@@H](N)Cc1ccccc1)S(=O)(=O)c1ccc([N+](=O)[O-])cc1]

12. A compound of the following formula [chemical structure]
